(19) United States
(12) Patent Application Publication
(10) Pub. No.: US 2025/0312701 A1
(43) Pub. Date: Oct. 9, 2025

(54) SYSTEM AND METHOD FOR INTERACTIVE MUSICAL GAMEPLAY WITH SYNCHRONIZED LYRICS

(71) Applicant: Gehan Rajasekaran, London (GB)

(72) Inventor: Gehan Rajasekaran, London (GB)

(73) Assignee: Escaped Pixels Limited, London, EN (GB)

(21) Appl. No.: 18/629,520

(22) Filed: Apr. 8, 2024

(51) Int. Cl. A63F 13/814; G06F 3/0488

(52) U.S. Cl. CPC A63F 13/814; G06F 3/0488

(57) ABSTRACT

A system and method for interactive musical gameplay on a portable computing device are disclosed. The system includes a musical play module for playing a musical composition, a lyrics synchronization module for synchronizing lyrics with the musical play, and a gamified interface generation module for displaying a gamified interface comprising playful elements (tiles) containing portions of the synchronized lyrics. A user input processing module receives user input indicating the selection of one or more tiles, and a feedback module provides feedback based on the correctness of the user's selection. The method involves playing the musical composition, synchronizing lyrics, generating and displaying the gamified interface, receiving user input, and providing feedback. Some embodiments may include touch or gesture-based input, machine learning-based lyrics generation, automatic lyric translation, game reset upon user failure, pregenerated or on-demand tile generation, and visual correction feedback. The invention enhances user engagement and interactivity in musical gameplay.

### FIELD OF THE DISCLOSURE

The present invention relates to the field of interactive musical gameplay systems and methods, particularly those implemented on portable computing devices. Specifically, aspects of the invention combine music playback, lyric synchronization, and gamification to create an engaging user experience.

### BACKGROUND

Music has always been an integral part of human culture, with people constantly seeking new ways to engage with and enjoy musical content. In recent years, the advent of portable computing devices, such as smartphones and tablets, has revolutionized the way people interact with music. These devices have become powerful platforms for music playback, allowing users to access vast libraries of songs on the go.

However, the traditional music playback experience on portable devices often lacks interactivity and engagement. Users passively listen to songs without actively participating in the musical experience. This limitation has led to a growing interest in developing innovative ways to enhance user engagement with musical content on portable devices.

Recent developments in the field of interactive music systems have explored various approaches to make music playback more engaging. Some systems have introduced gameplay elements, such as rhythm-based tapping or instrument simulation, to allow users to interact with the music. Others have focused on visualizations, such as synchronized lyrics or music videos, to provide a more immersive experience.

Despite these advancements, there remains a significant opportunity to create a more comprehensive and interactive musical gameplay experience on portable devices. The challenges lie in effectively combining music playback, lyric synchronization, and gamification elements in a seamless and intuitive manner. Additionally, there is a need for real-time feedback and adaptability to keep users engaged and motivated.

The object of the present invention is to provide a system and method for interactive musical gameplay on portable computing devices that addresses these challenges and opportunities, offering users a highly engaging and immersive experience with musical content.

### SUMMARY

[1] Embodiments of the present disclosure may include a system for interactive musical gameplay, including a portable computing device with a display and an input mechanism. Embodiments may also include a musical play module configured to play a musical composition. Embodiments may also include a lyrics synchronization module configured to synchronize a plurality of lyrics associated with the musical composition to the musical play.

Embodiments may also include a gamified interface generation module configured to generate and display on the display a gamified interface including a plurality of playful elements (tiles), each tile containing a portion of the synchronized lyrics. Embodiments may also include a user input processing module configured to receive and process user input from the input mechanism, the user input indicating a selection of one or more of the tiles. Embodiments may also include a feedback module configured to provide feedback to the user based on the user input, the feedback indicating whether the selected one or more tiles correspond to the correct synchronized lyrics.

In some embodiments, the input mechanism may be a touch-sensitive device, and the user input may be received through touch interactions on the touch-sensitive device. In some embodiments, the user input may be received through gestures detected by the input mechanism. In some embodiments, the system may include a lyrics generation module that employs machine learning techniques to generate the lyrics on-demand based on the musical composition.

In some embodiments, the system may include a lyrics translation module configured to automatically translate the lyrics into different languages. In some embodiments, the gamified interface generation module may be configured to reset the gaming activity when the user fails to select the correct tile corresponding to the synchronized lyrics.

In some embodiments, the plurality of playful elements (tiles) may be pregenerated and stored in a database associated with the musical composition. In some embodiments, the plurality of playful elements (tiles) may be generated on-demand by the gamified interface generation module based on the synchronized lyrics. In some embodiments, the feedback provided by the feedback module may be a visual correction that highlights the correct tile corresponding to the synchronized lyrics when the user selects an incorrect tile.

Embodiments of the present disclosure may also include a method for interactive musical gameplay on a portable computing device, the method including playing a musical composition. Embodiments may also include synchronizing a plurality of lyrics associated with the musical composition to the musical play. Embodiments may also include generating and displaying a gamified interface including a plurality of playful elements (tiles), each tile containing a portion of the synchronized lyrics. Embodiments may also include receiving and processing user input indicating a selection of one or more of the tiles. Embodiments may also include providing feedback to the user based on the user input, the feedback indicating whether the selected one or more tiles correspond to the correct synchronized lyrics.

In some embodiments, the user input may be received through touch interactions on a touch-sensitive device. In some embodiments, the user input may be received through gestures detected by an input mechanism. In some embodiments, the method may include generating the lyrics on-demand based on the musical composition using machine learning techniques.

In some embodiments, the method may include automatically translating the lyrics into different languages. In some embodiments, the method may include resetting the gaming activity when the user fails to select the correct tile corresponding to the synchronized lyrics. In some embodiments, the plurality of playful elements (tiles) may be pregenerated and stored in a database associated with the musical composition. In some embodiments, the plurality of playful elements (tiles) may be generated on-demand based on the synchronized lyrics. In some embodiments, the feedback provided to the user may be a visual correction that highlights the correct tile corresponding to the synchronized lyrics when the user selects an incorrect tile.

### BRIEF DESCRIPTION OF THE DRAWINGS

The novel features believed to define the illustrative embodiments are detailed in the appended claims. To fully comprehend these embodiments, along with their preferred usage, objectives, and detailed descriptions, one should refer to the comprehensive description of the one or more examples of these embodiments, as provided in this disclosure. This understanding is further enhanced when considered alongside the accompanying drawings, wherein:

FIG. 1 is a block diagram illustrating a system, according to some embodiments of the present disclosure.

FIG. 2 is a flowchart illustrating a method, according to some embodiments of the present disclosure.

### DETAILED DESCRIPTION

The following detailed description sets forth the preferred embodiments of the present invention, an interactive musical gameplay system and method for portable computing devices, with reference to the accompanying drawings. The terminology and phraseology used in both the description and the claims should be interpreted in the context of the invention, reflecting the meanings and concepts as defined by the inventor(s) to best describe and convey the novelty and inventiveness of the interactive musical gameplay system and method.

It should be understood that the embodiments of the invention described and illustrated herein are presented as exemplary implementations and are not intended to limit the scope or technical essence of the invention. Various modifications, alterations, and adaptations can be made to the interactive musical gameplay system and method without departing from the spirit and scope of the invention. For instance, the system may incorporate additional input mechanisms, gamification elements, or customization options to enhance user engagement and personalization, while still adhering to the core inventive concept of providing an immersive and interactive musical gameplay experience on portable computing devices.

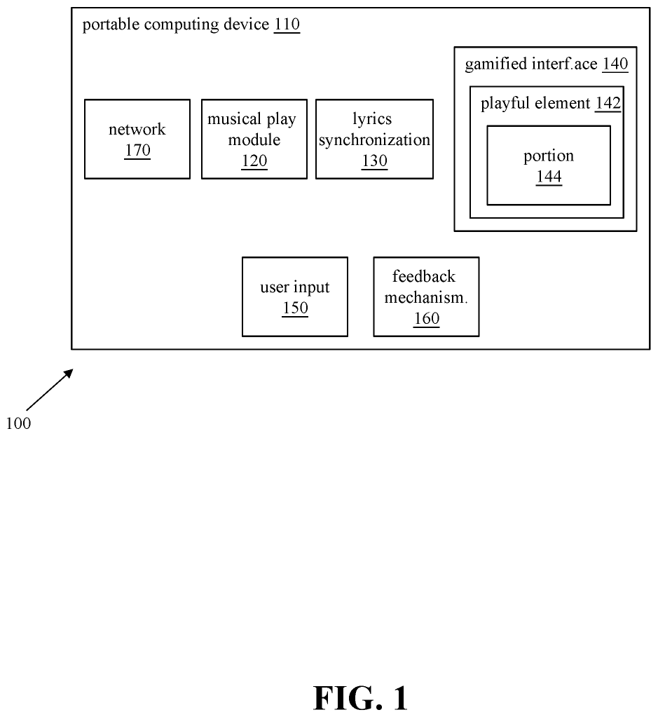

FIG. 1 is a block diagram that describes a system 100, according to some embodiments of the present disclosure. In some embodiments, the system 100 may include a portable computing device 110 with a display and an input mechanism, a musical play module 120 configured to play a musical composition, a lyrics synchronization module 130 configured to synchronize a plurality of lyrics associated with the musical composition to the musical play, and a gamified interface generation module 140 configured to generate and display on the display a gamified interface.

In some embodiments, the system 100 may also include a user input processing module 150 configured to receive and process user input from the input mechanism, the user input indicating a selection of one or more of the tiles. The system 100 may also include a feedback module 160 configured to provide feedback to the user based on the user input, the feedback indicating whether the selected one or more tiles correspond to the correct synchronized lyrics. The gamified interface generation module 140 may include a plurality of playful elements 142 (tiles). The plurality of playful elements 142 may include a portion 144 of the synchronized lyrics.

In some embodiments, the input mechanism may be a touch-sensitive device, and the user input may be received through touch interactions on the touch-sensitive device. In some embodiments, the user input may be received through gestures detected by the input mechanism. In some embodiments, the system 100 may include a lyrics generation module that employs machine learning techniques to generate the lyrics on-demand based on the musical composition.

In some embodiments, the system 100 may include a lyrics translation module configured to automatically translate the lyrics into different languages. In some embodiments, the gamified interface generation module 140 may be configured to reset the gaming activity when the user may fail to select the correct tile corresponding to the synchronized lyrics. In some embodiments, the plurality of playful elements 142 (tiles) may be pregenerated and stored in a database associated with the musical composition. In some embodiments, the plurality of playful elements 142 (tiles) may be generated on-demand by the gamified interface generation module 140 based on the synchronized lyrics. In some embodiments, the feedback provided by the feedback module 160 may be a visual correction that highlights the correct tile corresponding to the synchronized lyrics when the user may select an incorrect tile.

In some embodiments, the system 100 may further include a network module 170 configured to enable the portable computing device 110 to connect to remote devices, such as machine learning servers or application servers, over a network. The network module 170 may utilize various wireless communication protocols, such as Wi-Fi, cellular networks (e.g., 4G or 5G), or Bluetooth, to establish secure connections with the remote devices. By connecting to machine learning servers, the system 100 can leverage powerful cloud-based resources to perform computationally intensive tasks, such as lyric generation, data analysis, or model training, offloading these processes from the portable computing device 110. Additionally, the network module 170 may facilitate communication with application servers, allowing the system 100 to receive updates, access online leaderboards, or participate in multiplayer gameplay sessions, further enhancing the user's interactive musical gameplay experience and providing opportunities for social engagement and competition.

In some embodiments, the interactive musical gameplay system 100 may offer different levels or modes of play, catering to various skill levels and preferences. Exemplary and non-limiting examples of these modes may include a “Rockstar Mode” and a “Legend Mode,” each presenting unique challenges and gameplay mechanics.

In the “Rockstar Mode,” the gamified interface generation module 140 may display a single tile per row, containing a portion of the synchronized lyrics. The lyrics synchronization module 130 ensures that the tiles descend from the top of the screen in sync with the corresponding vocal track played by the musical play module 120. The user input processing module 150 tracks the player's taps on the tiles, while the feedback module 160 provides real-time feedback on the timing accuracy. To achieve a perfect score, the player must tap the tile when it aligns with a designated “TARGET” area, such as a white bar, indicating the optimal timing. The game's difficulty may adapt based on the player's performance, with the speed of the tiles increasing as the player demonstrates mastery.

In the “Legend Mode,” the gamified interface generation module 140 may present a higher level of challenge by displaying two or more tiles per row, each containing different lyrics segments. The player must quickly identify and tap the correct tile that corresponds to the current vocal track. Similar to the “Rockstar Mode,” the lyrics synchronization module 130 ensures that the tiles align with the music, and the user input processing module 150 and feedback module 160 track the player's performance and provide feedback. The “TARGET” area remains the key to achieving a perfect score, requiring precise timing and accuracy.

The system 100 may implement these modes using various techniques, such as adjusting the speed and frequency of tile generation, increasing the number of simultaneous tiles, and introducing distractors or obstacles. The difficulty progression may be predetermined or dynamically adjusted based on the player's performance, ensuring an engaging and challenging experience for players of all skill levels. Additionally, the system 100 may include leaderboards, achievements, and rewards to incentivize players to improve their scores and compete with others, leveraging the network module 170 to connect with remote platforms 104 for social features and gameplay data synchronization.

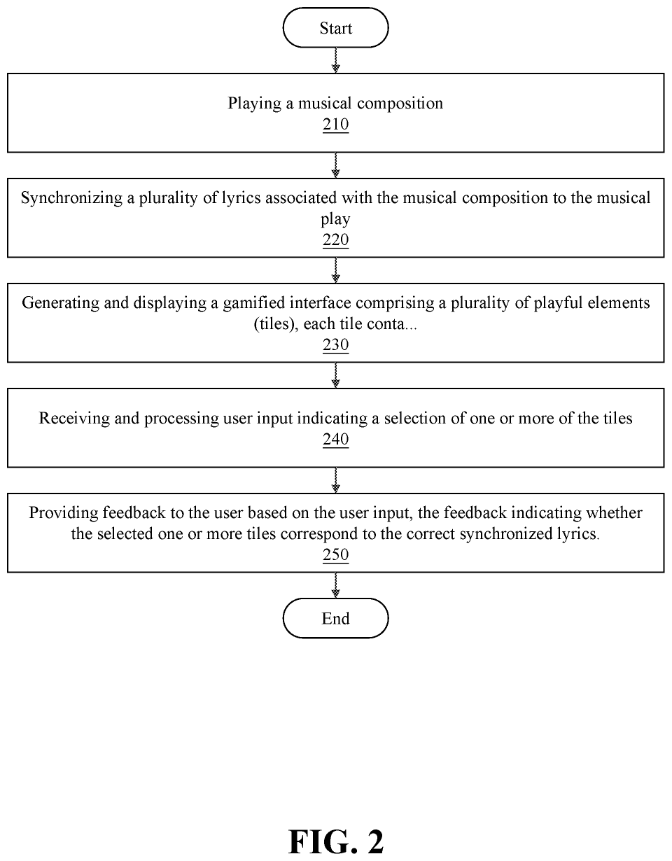

FIG. 2 is a flowchart that describes a method, according to some embodiments of the present disclosure. In some embodiments, at 210, the method may include playing a musical composition. At 220, the method may include synchronizing a plurality of lyrics associated with the musical composition to the musical play. At 230, the method may include generating and displaying a gamified interface comprising a plurality of playful elements (tiles), each tile containing a portion of the synchronized lyrics. At 240, the method may include receiving and processing user input indicating a selection of one or more of the tiles. At 250, the method may include providing feedback to the user based on the user input, the feedback indicating whether the selected one or more tiles correspond to the correct synchronized lyrics.

In some embodiments, the user input may be received through touch interactions on a touch-sensitive device. In some embodiments, the user input may be received through gestures detected by an input mechanism. In some embodiments, the method may include generating the lyrics on-demand based on the musical composition using machine learning techniques. In some embodiments, the method may include automatically translating the lyrics into different languages.

In some embodiments, the method may include resetting the gaming activity when the user fails to select the correct tile corresponding to the synchronized lyrics. In some embodiments, the plurality of playful elements (tiles) may be pregenerated and stored in a database associated with the musical composition. In some embodiments, the plurality of playful elements (tiles) may be generated on-demand based on the synchronized lyrics. In some embodiments, the feedback provided to the user may be a visual correction that highlights the correct tile corresponding to the synchronized lyrics when the user may select an incorrect tile.

### INDUSTRIAL APPLICATION

The interactive musical gameplay system and method have broad applications in the entertainment and gaming industry. The invention can be implemented as a standalone mobile application or integrated into existing music streaming platforms, providing a new layer of user engagement and interactivity. Game developers can leverage this technology to create music-based games that challenge users to sync with lyrics, while educational institutions can use it to make music learning more engaging and accessible. The invention's adaptability to various genres and customization options make it attractive for music labels and artists looking to offer unique fan experiences. As the demand for interactive content grows, this invention has the potential to revolutionize the way people consume and engage with music on their portable devices.

What is claimed is:

1. A system for interactive musical gameplay, comprising:
a portable computing device with a display and an input mechanism;
a musical play module configured to play a musical composition;
a lyrics synchronization module configured to synchronize a plurality of lyrics associated with the musical composition to the musical play;
a gamified interface generation module configured to generate and display on the display a gamified interface comprising a plurality of playful elements (tiles), each tile containing a portion of the synchronized lyrics;
a user input processing module configured to receive and process user input from the input mechanism, the user input indicating a selection of one or more of the tiles; and
a feedback module configured to provide feedback to the user based on the user input, the feedback indicating whether the selected one or more tiles correspond to the correct synchronized lyrics.

2. The system of claim 1, wherein the input mechanism is a touch-sensitive device, and the user input is received through touch interactions on the touch-sensitive device.

3. The system of claim 1, wherein the user input is received through gestures detected by the input mechanism.

4. The system of claim 1, further comprising a lyrics generation module that employs machine learning techniques to generate the lyrics on-demand based on the musical composition.

5. The system of claim 1, further comprising a lyrics translation module configured to automatically translate the lyrics into different languages.

6. The system of claim 1, wherein the gamified interface generation module is configured to reset the gaming activity when the user fails to select the correct tile corresponding to the synchronized lyrics.

7. The system of claim 1, wherein the plurality of playful elements (tiles) are pregenerated and stored in a database associated with the musical composition.

8. The system of claim 1, wherein the plurality of playful elements (tiles) are generated on-demand by the gamified interface generation module based on the synchronized lyrics.

9. The system of claim 1, wherein the feedback provided by the feedback module is a visual correction that highlights the correct tile corresponding to the synchronized lyrics when the user selects an incorrect tile.

10. A method for interactive musical gameplay on a portable computing device, the method comprising:
playing a musical composition;
synchronizing a plurality of lyrics associated with the musical composition to the musical play;
generating and displaying a gamified interface comprising a plurality of playful elements (tiles), each tile containing a portion of the synchronized lyrics;
receiving and processing user input indicating a selection of one or more of the tiles; and
providing feedback to the user based on the user input, the feedback indicating whether the selected one or more tiles correspond to the correct synchronized lyrics.

11. The method of claim 10, wherein the user input is received through touch interactions on a touch-sensitive device.

12. The method of claim 10, wherein the user input is received through gestures detected by an input mechanism.

13. The method of claim 10, further comprising generating the lyrics on-demand based on the musical composition using machine learning techniques.

14. The method of claim 10, further comprising automatically translating the lyrics into different languages.

15. The method of claim 10, further comprising resetting the gaming activity when the user fails to select the correct tile corresponding to the synchronized lyrics.

16. The method of claim 10, wherein the plurality of playful elements (tiles) are pregenerated and stored in a database associated with the musical composition.

17. The method of claim 10, wherein the plurality of playful elements (tiles) are generated on-demand based on the synchronized lyrics.

18. The method of claim 10, wherein the feedback provided to the user is a visual correction that highlights the correct tile corresponding to the synchronized lyrics when the user selects an incorrect tile.
